(19) United States
(12) Patent Application Publication
(10) Pub. No.: US 2016/0162660 A1
(43) Pub. Date: Jun. 9, 2016

(54) MEDICATION MANAGEMENT

(71) Applicant: EBAY INC., San Jose, CA (US)

(72) Inventor: Margaret A. Strong, Spicewood, TX (US)

(21) Appl. No.: 14/559,879

(22) Filed: Dec. 3, 2014

(51) Int. Cl. G06F 19/00; A61J 7/00; B65D 83/04

(52) U.S. Cl. CPC G06F 19/3462; B65D 83/04; A61J 7/0076; B65D 2585/56

(57) ABSTRACT

Methods and systems for managing medications of a patient are described. A dispenser device having compartments for holding medications and containing a patient profile is provided. The dispenser device is delivered to a pharmacist, who can fill the dispenser device and bill a patient based on the patient profile. The pharmacist can access medical records and other information, such as insurance and payment information, that is needed to fill the prescription, by reading the patient profile. In various embodiments, the dispenser device includes a security component to control that accesses the dispenser device.

### BACKGROUND

1. Field of the Invention

The present invention generally relates to drug dispensing, and more specifically to drug dispensing that is less prone to abuse and poor patient compliance.

2. Related Art

The ever increasing aging or elderly population is taking more prescriptions than any other group in history, while dispensing methods have remained relatively unchanged. Major obstacles with drug dispensing include the increasing cost of drugs, prescribing and dispensing errors, and poor patient compliance. Poor patient compliance leads to enormous costs with respect to wasted drugs and sub-optimal treatments. The effects of sub-optimal treatments can be exponential as they may lead to lingering or recurrent illnesses, thus demanding more doctor visits, more hospitalization and more surgical and/or medical treatment.

There are currently no management plans, however, that can assure that correct dosages are being taken, and that prescriptions are being dispensed in a timely manner. In fact, the elderly may often go to multiple pharmacies for prescription filling, where pharmacists may not know what other pharmacies are dispensing to the patient. Moreover, the elderly or disabled who are living alone are often dependent on caregivers or neighbors to organize their medications into daily dosages. Often, the caregivers or neighbors are also entrusted with cash or credit to purchase the medications. This can result in identity theft, fraud, and failure to deliver the medications. Thus, improved methods and systems for managing medications are needed.

### BRIEF DESCRIPTION OF THE FIGURES

FIG. 1 is a block diagram illustrating a system for managing medications of a patient according to an embodiment of the present disclosure;

FIG. 2 is a block diagram illustrating a service provider server according to an embodiment of the present disclosure;

FIG. 3 is a flowchart showing a method for managing medications of a patient according to an embodiment of the present disclosure; and

FIG. 4 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods of managing medications for a patient. A service provider provides a dispenser device for purchase to a patient. The dispenser device can also be offered as part of a service provided by drugstores, pharmacies, or hospitals. The dispenser device, in various embodiments, includes patient information such as the patient's entire portfolio of medications, insurance information, and payment information. The patient information may be obtained from the patient and/or the patient's physician. When a pharmacy receives the dispenser device, it is able to read the patient information, load the appropriate medications into the dispenser device, and charge the patient the appropriate amount for the medications. The dispenser device can then be delivered to the patient. According to certain embodiments, the patient must be authenticated before he or she is allowed access to the medications in the dispenser device. For example, the patient may be required to enter a password or PIN, fingerprint, voice, etc. In other embodiments, the dispenser device monitors when a patient opens and closes the dispenser device to take his or her medications. This information can then be sent to the patient's physician to track patient compliance.

In various embodiments, the dispenser device is provided to and used by a patient's caregiver (e.g., nurse, spouse, caretaker, parent, legal guardian, etc.) to ensure that the patient is taking the correct medications at the right time. For example, the caregiver can purchase and bring the dispenser device to the pharmacy to be filled and bring the dispenser device back to the patient. During the times a medication is to be administered, the caregiver can be notified so that the proper medication is provided to the patient.

As used herein, a “patient” is a human being in need of at least one prophylactic or therapeutic medication. The medication typically is a prescription medication, but also may be an over-the-counter (OTC) medication. In an exemplary embodiment, each patient has a unique patient profile that lists personal information (name, address, etc.) about the patient as well as the details of their medication information, including their medication dosage schedule. Non-limiting examples of different patient types may include mid-late life or elderly patients (e.g., patients with an average age of 79 years old that may suffer from multiple chronic diseases, short memory, and/or are physically challenged), patients with complex multi-medication regimens, depression patients (e.g., patients may be of any age range), special needs patients, and medication abuser/diverter patients. The patient profile can be stored either on the dispenser device itself or at a service provider server. In some embodiments, the patient profile also will include distinguishable physical identity information (e.g., fingerprint, biometric shape of fingers or hands, retinal scan profile, voice, etc.) to ensure the patient is the one who accesses the medication in the dispenser device.

The present disclosure incorporates technology into a dispenser device that organizes dosages, automated payment technologies, and security to ensure that patients get the medications they need when they need them. The methods and systems described herein automate many of the complicated billing and consumer confusion among patients that frequently accompany the dispensing of prescriptions. Advantageously, no sensitive financial information is revealed to the person taking the dispenser device to the pharmacy or the pharmacist.

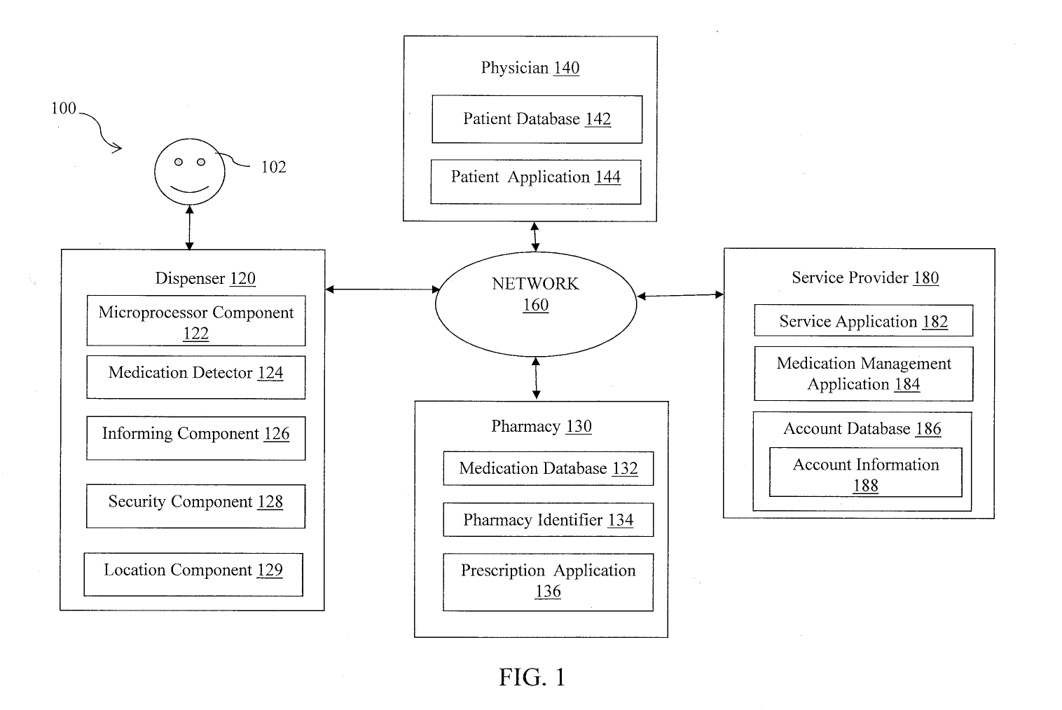

FIG. 1 shows one embodiment of a block diagram of a network-based system 100 adapted to manage medications for a user, such as patient 102. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a dispenser device 120, a pharmacy server or device 130, a physician server or device 140, and at least one service provider server or device 180 (e.g., network server device). The dispenser device 120, pharmacy server 130, physician server 140, and service provider server 180 are in communication over the network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The dispenser device 120, in several embodiments, is sold or otherwise provided by a service provider and includes one or more compartments for holding tablets, capsules, or pills (collectively “pills”). Each compartment can house one or more pills. The dispenser device 120 typically includes several compartments that store pills or medications for a certain period of time, e.g., for each day of the week, for several weeks, or for a month. In some embodiments, there can be one compartment for each day, two compartments for each day, or three compartments for each day. The number of compartments may correspond to the number of times the patient 102 is required to take medication throughout a particular day. For instance, a patient that is required to take medication three times a day (e.g., at breakfast, lunch and dinner) could use a dispenser device 120 with three compartments.

As an example, the dispenser device 120 may be a medication strongbox or lockbox that delivers medication to a patient at preset time intervals. The time intervals can be constant, or they can vary, depending on the particular medication regimen in effect. The dispenser device 120 can be pre-loaded with the set of medications related to the patient's medical condition, potential secondary conditions, and prior patient medical history.

The arrangement of the medications within the dispenser device 120 allows for the patient 102 to manage a large number of pills, without having to recall which pills need to be taken and when. Similarly, the patient's caregiver (e.g., nurse, spouse, neighbor, or family member) can easily determine which doses have or have not been taken. The dispenser device 120 reduces the chances that patient 102 will miss a dose or duplicate a dose. Moreover, the dispenser device 120 provides significant value to the elderly and handicapped who frequently are prescribed large quantities of medications for various ailments, but who may have trouble keeping track of such medication.

According to various embodiments, the dispenser device 120 includes a microprocessor component 122 (e.g., chip) that allows the dispenser device 120 to be monitored and programmed remotely. For example, a physician associated with the physician server 140 can monitor whether or not patient 102 is taking his or her medications based on information recorded on the microprocessor component 122, and the physician can update prescriptions stored on the microprocessor component 122. The microprocessor component 122, in some embodiments, includes the patient 102's profile. The patient profile includes information including medical and personal data relevant to the patient 102. This can include, but is not limited to, name, address, medical history, social security number, insurance information, providers used, prescriptions, biometric data, compliance history, medication schedules, current location, and financial/payment data (e.g., banking information and/or funding sources such as one or more banking institutions, credit card issuers, user account numbers, security data and information, etc.). In alternative embodiments, the patient profile is stored on a code placed on the dispenser device 120, such as a barcode (e.g., Quick Response (QR) code). A code reader can then be used to read the information in the code.

Medication consumption by patient 102 can be monitored, in one embodiment, by including a medication detector 124 on the dispenser device 120. The medication detector 124 may include a weight sensor configured to detect a weight of contents of one or more compartments, a motion sensor configured to detect opening and closing of the dispenser device 120, or a sensor configured to detect when patient 102 (or any other person) enters authentication data to access the dispenser device 120. In certain embodiments, the motion sensor can track and log each time a compartment is opened and/or closed. The dispenser device 120 can contain electronics or any other mechanism that detects the opening and closing of a compartment and logs this event, for example, on the microprocessor component 122. In some embodiments, when and who accesses the dispenser device 120 is monitored and communicated to the service provider and/or a physician. In exemplary embodiments, the dispenser device 120 (e.g., via the microprocessor component 122) notifies patient 102 (e.g., via an alarm, light, email, etc.) and/or physician if patient 102 has not accessed the medications in the dispenser device 120 by a certain time.

The dispenser device 120, in various embodiments, may be implemented using any appropriate combination of hardware and/or software configured for wired and/or wireless communication over the network 160. The dispenser device 120, in one embodiment, may automatically transmit information (e.g., medication consumption information) to pharmacy server 130, physician server 140, and/or service provider server 180. In other embodiments, pharmacy server 130, physician server 140, and/or service provider server 180 can access, monitor, and/or change information stored on the microprocessor component 122 of the dispenser device 120. Thus, the dispenser device 120 is able to communicate with external devices.

In exemplary embodiments, the dispenser device 120 is the size of a computer tablet or laptop. In these embodiments, the compartments of the dispenser device 120 are large enough so that patient 102 can easily fit his or her finger into each compartment. The larger size of the compartments makes it easier for a handicapped, elderly or arthritic patient with limited dexterity to access pills. Moreover, the size of the dispenser device 120 allows those patients with impaired vision to more easily see what medication needs to be taken on a particular day, as well as which medication has already been taken.

The dispenser device 120 may be made of a durable material, such as plastic. Plastic can be an ideal material for the dispenser device 120 because plastics are often inexpensive and therefore would not increase the cost of a patient's prescription. Further, a plastic dispenser can be returned to the pharmacist to be re-used for subsequent prescriptions. For more security, a harder or more tamper-proof material may be used, such as metal.

In certain embodiments, the dispenser device 120 contains one or more components for informing a patient 102 (“informing component 126”) about the relevance of each respective compartment and/or the medication regimen sequence associated with each compartment. For example, the dispenser device 120 may include a light bulb or light emitting diode (LED) in proximity to each compartment that is activated at the appropriate regimen time, a locking component for all compartments that locks the compartments except for the compartment associated with the appropriate medication regimen sequence, and/or an opening component to open a latch associated with the appropriate compartment. Various latches can be used, which would allow access (unlock) or deny access (lock) through various methods, such as biometrics, PIN/password entry, etc.

According to various aspects, the dispenser device 120 includes a location component 129 that determines, tracks, monitors, and/or provides an instant geographical location of dispenser device 120. In one implementation, the geographical location may include GPS coordinates, zip-code information, area-code information, street address information, and/or various other generally known types of location data or information. For example, in one embodiment, the location component includes a radio-frequency identification (RFID) tag. The RFID tag can help patient 102 keep track of the location of dispenser device 120. For example, a RFID reader can pick up the signal given off by the RFID tag so that patient 102 can find dispenser device 120 quickly. An RFID tag may also allow tracking of the dispenser device 120. In other embodiments, the location component 129 communicates the location of dispenser device 120 to the service provider, patient 102, and/or physician.

The dispenser device 120 is generally easy to load by a drug supplier (e.g., pharmacist). For example, a pharmacist can load the dispenser device 120 with the patient 102's weekly medication. The pharmacist could further load more than one dispenser device 120 so that the patient 102 can take home one month's worth of medication. This is particularly useful for patients who are on chronic drug administration, wherein the prescriptions rarely change from one month to the next. As a result, when patient 102 (or a caregiver) goes to the pharmacy to pick up medication, he or she can take home a pre-loaded dispenser device 120 or multiple pre-loaded dispenser devices 120 and already have his or her pills appropriately segregated for the proper day and dosing periods. Dispenser device 120 can also be loaded or the prescription filled and mailed to the patient 102 (or caregiver).

According to several exemplary embodiments, the dispenser device 120 is stackable. These embodiments may be ideal for patients who wish to have more than one dispenser device 120's supply of medication in their possession. For instance, four stacked dispenser devices 120 can provide approximately one month's supply of medication. Ideally, when the patient 102 (or a caregiver) goes to the pharmacy to pick up his or her medication, the pharmacist can provide the patient 102 with four preloaded dispenser devices 120, which can be conveniently stacked. Once the patient 102 takes the first week's supply of medication, he or she simply has to remove the top dispenser device 120, and then proceed to take the next week's supply of medication from the next dispenser device 120.

In some embodiments, the pharmacist, physician, and/or patient 102 must authenticate themselves to the dispenser device 120 to load and/or access the contents of the dispenser device 120. The dispenser device 120 may include a security or user identification component 128 to confirm the identity of the person accessing the dispenser device 120. The security or user identification component 128 may be structured such that it can detect a fingerprint, biometric shape of the user's hand or finger, or retinal scan profile. Alternatively or additionally, the component 128 may employ voice recognition technology. In other embodiments, a PIN code is required to manipulate the dispenser device 120, including loading medications, setting or changing the dosing and dispensing schedule, and/or accessing medications stored in the dispenser device 120.

In various implementations, patient 102 (or any other person such as a caregiver) is able to input data and information into an input component (e.g., touchscreen, keyboard, keypad, microphone, etc.) of dispenser device 120 to provide authentication information and/or patient information.

The one or more pharmacy servers 130, in various embodiments, may be maintained by one or more entities that act as a retail supplier of medication substances, including prescription medications. In some embodiments, the entities may need to register with the service provider as part of offering various medications to patient 102. Each of the one or more pharmacy servers 130 may include a medication database 132 for identifying available medications, which may be made available to patient 102 and loaded into dispenser device 120. In one or more embodiments, patient 102 may complete a transaction with pharmacy server 130, such as purchasing one or more medications, via service provider server 180.

Each of the pharmacy servers 130, in one embodiment, may include at least one pharmacy identifier 136, which may be included as part of the one or more medications made available for purchase. In one implementation, the pharmacy identifier 134 may include one or more attributes and/or parameters related to the pharmacy, such as business and banking information. The pharmacy identifier 134 may include attributes related to the pharmacy server or device 130, such as identification information (e.g., a serial number, a location address, GPS coordinates, a network identification number, etc.). In various embodiments, patient 102 may conduct financial transactions (e.g., purchasing, and/or providing payment for medications) with each pharmacy server 130 via the service provider server 180 over the network 160.

In some embodiments, each of the pharmacy servers 130 includes a prescription application 136, which may be configured to provide information over the network 160 to the physician server 140 and/or service provider server 180. The information includes, for example, medications dispensed to patient 102, amount of medications dispensed, number of dispenser devices 120 provided to patient 102, and when medications were dispensed.

The pharmacy associated with the pharmacy server 130 can receive the dispenser device 120 from patient 102, a caregiver, or service provider, read prescription and insurance information on the dispenser device 120, and load the dispenser device 120 with the appropriate medications. The dispenser device 120 can then be picked up or delivered to patient 102.

The one or more physician servers 140, in certain embodiments, may be maintained by a physician or doctor permitted to prescribe medications for a patient (e.g., patient 102). The physician server 140, in one embodiment, includes a patient database 142 that includes patient profile information including patient medical history, current medications, current patient condition, insurance information, etc.

Each of the physician servers 140 may also include a patient application 144 that allows the physician to monitor the dispenser device 120 and read and/or change patient information on the microprocessor component 122.

The service provider server 180, in one embodiment, may be maintained by a transaction processing entity, which may provide processing for financial and information transactions for patient 102. As such, the service provider server 180 includes a service application 182, which may be adapted to interact with the dispensing device 120 over the network 160. In one example, the service provider server 180 may be provided by PayPal®, Inc. or eBay® of San Jose, Calif., USA.

The service provider server 180, in one embodiment, may be configured to maintain one or more accounts in an account database 186 each of which may include account information 188 associated with one or more individual patients (e.g., patient 102) and pharmacies (e.g., pharmacy associated with pharmacy server 130). For example, account information 188 may include private financial information of patient 102 and each pharmacy associated with the one or more pharmacy servers 130, such as one or more account numbers, passwords, credit card information, banking information, or other types of financial information, which may be used to facilitate financial transactions between patient 102 and the one or more pharmacies associated with the pharmacy servers 130. In various aspects, the methods and systems described herein may be modified to accommodate patients and pharmacies that may or may not be associated with at least one existing patient account and/or pharmacy account, respectively.

In one implementation, the patient 102 may have identity attributes stored with the service provider server 180, and patient 102 may have credentials to authenticate or verify identity with the service provider server 180. Patient attributes may include personal information, banking information, and/or funding sources. In various aspects, the patient attributes may be passed to the service provider server 180 by the pharmacy server 140 during the filling of a prescription, and the patient attributes may be utilized by the service provider server 180 to associate patient 102 with one or more particular patient accounts maintained by the service provider server 180.

In various embodiments, service provider server 180 includes a medication management application 184. The medication management application 184, in one embodiment, receives patient information from physician server 140 and loads this information onto microprocessor component 122, sends a dispenser device 120 to a pharmacy or patient 102, receives a payment request from the pharmacy, and processes the payment. In some embodiments, the medication management application 184 instructs the dispenser device 120 to perform a variety of functions. For example, the medication management application 184 can instruct the dispenser device 120 to notify patient 102 to take his or her medications at a certain time, receive authentication information from patient 102, and/or provide access to medications in dispenser device 120 upon authentication.

In one embodiment, patient 102 (or a caregiver) can go on-line to a service provider website and view their prescriptions. Patient 102 also may be able to review what pills need to taken and when the pills need to be taken. In addition, patient 102 (or a caregiver) can perform various functions by visiting an online page and/or by sending email instructions (e.g., registering, billing, creating profiles, setting preferences, setting alarms, viewing compliance reports, viewing frequently asked questions, communicating with physician, etc.).

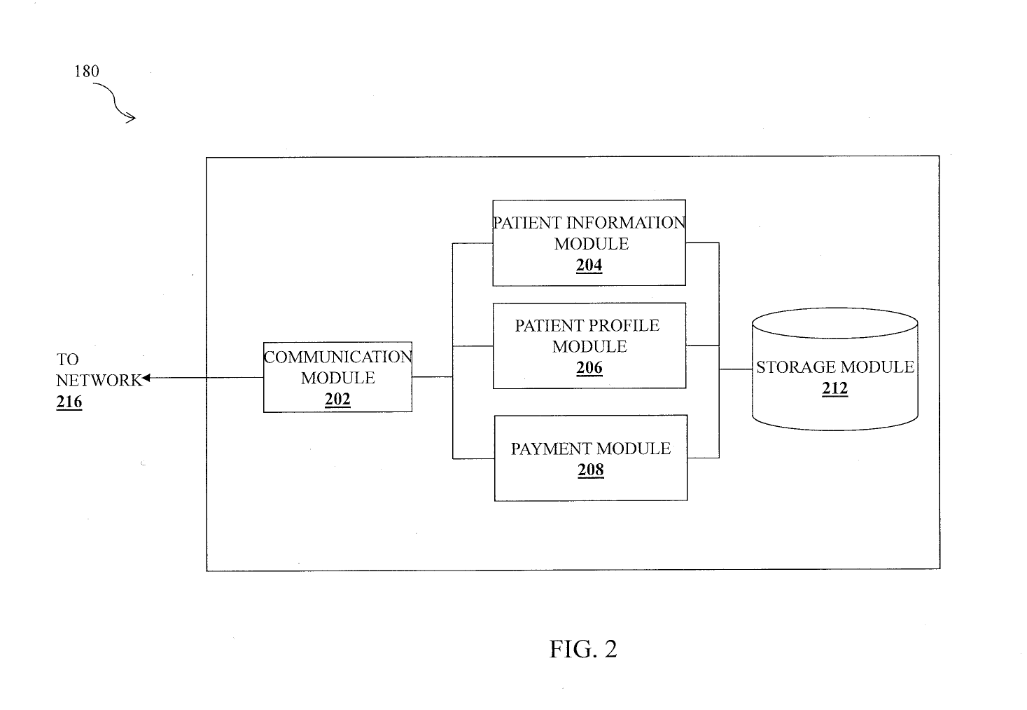

FIG. 2 illustrates an embodiment of a service provider server 180. The server 180 includes several components or modules, such as a communication module 202, patient information module 204, patient profile module 206, payment module 208, and storage module 212.

The server 180 can include a communication module 202 that is coupled to the network 216 and to any or all of a patient information module 204, patient profile module 206, and/or payment module 208, any of which may be coupled to a storage module 212. Any or all of the modules 202-208 may be implemented as a subsystem of the server 180 including for example, a circuit, a hardware component, a hardware subcomponent, and/or a variety of other subsystems known in the art. Furthermore, any or all of the modules 202-208 may be preconfigured to perform their disclosed functionality, or may be configured by a processing system “on-the-fly” or as needed to perform their disclosed functionality. As such, any or all of the modules 202-208 may include pre-configured and dedicated circuits and/or hardware components of the server 180, or may be circuits and/or hardware components that are configured as needed.

For example, any or all of the modules 202-208 may be provided via one or more circuits that include resistors, inductors, capacitors, voltage sources, current sources, switches, logic gates, registers, and/or a variety of other circuit elements known in the art. One or more of the circuit elements in a circuit may be configured to provide the circuit(s) that causes the modules 202-208 to perform the functions described below. As such, in some embodiments, preconfigured and dedicated circuits may be implemented to perform the functions of the modules 202-208. In other embodiments, a processing system may execute instructions on a non-transitory, computer-readable medium to configure one or more circuits as needed to perform the functions of the modules 202-208.

The communication module 202 may be included as a separate module provided in the server 180, or may be provided using instructions stored on a computer-readable medium that, when executed by a processing system in the server 180, configure the communication module 202 to send and receive information over the network 216, as well as provide any of the other functionality that is discussed herein. The communication module 202, for example, receives information from and sends information to the dispenser device 120, pharmacy server 130, and/or physician server 140. The patient information module 204 may be included as a separate module provided in the server 180, or may be provided using instructions stored on a computer-readable medium that, when executed by a processing system in the server 180, configure the patient information module 204 to receive patient information from a physician, transmit patient information to dispenser device 120, and store patient information on dispenser device 120, as well as provide any of the other functionality that is discussed herein. In some embodiments, the patient information module 204 receives a list of physicians associated with patient 102, transmits a request for patient information to the physicians, and receives patient information from the physician. The patient profile module 206 may be included as a separate module provided in the server 180, or may be provided using instructions stored on a computer-readable medium that, when executed by a processing system in the server 180, configure the patient profile module 206 to generate patient profiles from the received patient information, provide the patient profiles to dispenser device 120, monitor and/or receive medication consumption information from dispenser device 120, transmit the medication consumption information to one or more physicians, update patient profiles, instruct dispenser device 120 to notify patient 102 to take his or her medications at the appropriate time, and instruct dispenser device 120 to provide access to dispenser device 120 when a patient is authenticated. The payment module 208 may be included as a separate module provided in the server 180, or may be provided using instructions stored on a computer-readable medium that, when executed by a processing system in the server 180, configure the payment module 208 to receive payment requests from a pharmacy and process the payment requests, as well as provide any of the other functionality that is discussed herein. Furthermore, other modules discussed above but not illustrated in FIG. 2 may be provided as separate modules on the server 180, or using instructions stored on a computer-readable medium similarly as discussed above. Storage module 212 is configured to store patient and pharmacy information. While the storage module 212 has been illustrated as located in the server 180, one of ordinary skill in the art will recognize that it may include multiple storage modules and may be connected to the modules 204-208 through the network 216 without departing from the scope of the present disclosure.

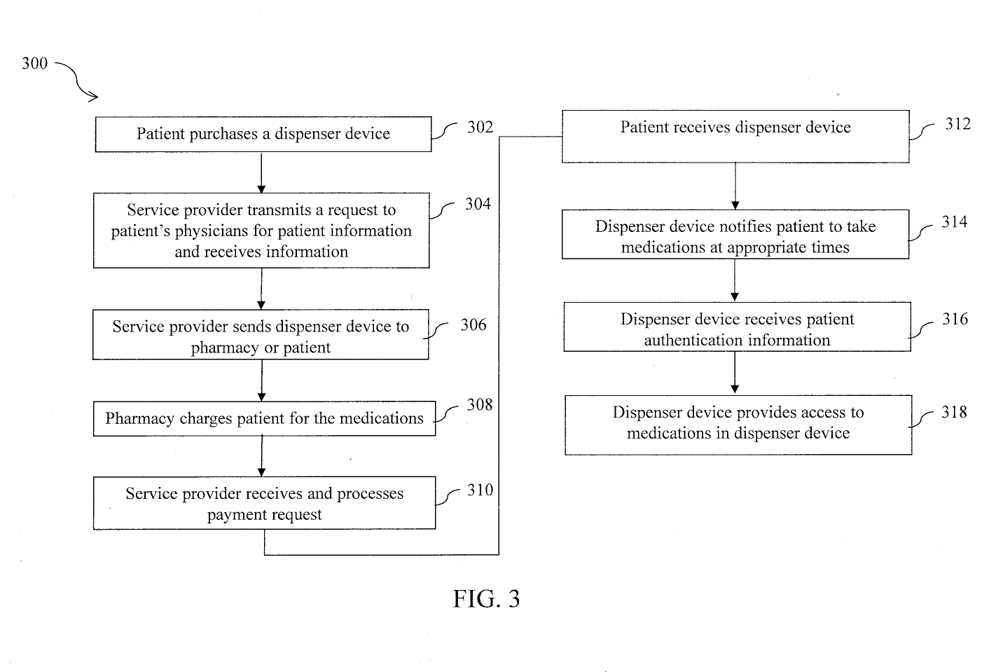

Referring now to FIG. 3, a flowchart 300 of a method for managing medications of a patient is illustrated according to an embodiment of the present disclosure. In various embodiments, the patient 102 registers with a service provider. Registration may include signing up for the medication management service and agreeing to any terms required by the service provider.

The patient 102 may be requested to provide specific information for registration, such as, but not limited to, a name, address, phone number, email address, medical insurance information, biometric information, picture, a user name for the account, and a password or PIN for the account. The type of information may depend on whether the patient already has an account with the service provider. Requested information may be entered through a user device or other means, including voice or manual key entry. Once all the requested information is received and confirmed, the service provider may create an account for the patient.

At step 302, patient 102 (or a caregiver) purchases a dispenser device 120 or purchases the medication management service from a service provider. For example, patient 102 can purchase dispenser device 120 off a website of the service provider. Patient 102 may purchase the medication management service from drugstores, pharmacies, or hospitals. In various embodiments, patient 102 registers the dispenser device 120 with the service provider online and identifies the physicians that patient 102 visits or is associated with.

At step 304, patient information module 204 transmits a request to the identified physicians and receives patient information from the identified physicians for the patient 102. For example, the patient information module 204 receives personal information and any other medical information associated with the patient 102 and the patient's medical history, e.g., current medications and dosage plans, allergies, alerts, preferred pharmacies, etc., for storage in the storage module 212. In some embodiments, a physician may upload the information from physician server 140 to service provider server 180. The information is received by the patient information module 204 and may then be locally stored on the dispenser device 120 (e.g., the information is stored on microprocessor component 122 or on a barcode).

At step 306, patient information module 204 sends the dispenser device 120 to a participating pharmacy (e.g., pharmacy associated with pharmacy server 130) or to patient 102. Patient 102 (or a caregiver) can also bring the dispenser device 120 to the pharmacy. Once the pharmacy receives dispenser device 120, a pharmacy technician may be required to authenticate himself or herself to the dispenser device 120. When the pharmacy technician is authenticated, the pharmacy can read prescription information on the microprocessor component 122 (or barcode) and fill the dispenser device 120 with the appropriate medications.

At step 308, the pharmacy charges the patient 102 for the medications. For example, the pharmacy may read the insurance information provided on the dispenser device 120 and determine what the co-payment for the medications are. The pharmacy can then request the co-payment amount from the service provider.

At step 310, payment module 208 receives the payment request from the pharmacy and processes payment for the medications. For example, a patient account is debited and an amount credited or transferred to a pharmacy account.

At step 312, patient 102 receives dispenser device 120. In various embodiments, patient 102 (or a caregiver) picks up the dispenser device 120 from the pharmacy. In other embodiments, the dispenser device 120 is mailed to patient 102.

At step 314, the dispenser device 120 (e.g., via informing component 126) notifies patient 102 to take his or her medications at appropriate time(s). In one example, the patient profile module 206 provides instructions and/or schedule information to microprocessor component 122 regarding when patient 102 is supposed to take his or her medications. In various embodiments, dispenser device 120 has an internal clock with a timer, which triggers the time sensitive functions of the dispenser device 120 so that patient 102 is notified when he or she needs to take medication. For example, an alarm on the dispenser device 120 may sound, a light on the dispenser device 120 may light up, etc. In some embodiments, dispenser device 120 may send an email or message reminder to patient 102. In certain embodiments, however, patient 102 is not notified and remembers to take the medications on his or her own.

At step 316, dispenser device 120 (e.g., via security component 128) receives authentication information from patient 102. For example, patient 102 can provide a PIN, password, fingerprint, voice, biomarker, etc. In some embodiments, the dispenser device 120 transmits the authentication information to the patient profile module 206, and the patient profile module 206 authenticates the patient by comparing a stored characteristic to an obtained characteristic. If the characteristics match, the patient is authenticated.

At step 318, once patient 102 is authenticated, the dispenser device 120 (e.g., via microprocessor component 122) provides access to the medications to patient 102. In various embodiments, a LED light lights up a compartment that holds the medication(s) to be taken so that patient 102 knows which pills to take. In some embodiments, a sensor monitors when dispenser device 120 (or its compartments) is opened and closed. The information can be sent to a physician so that the physician can determine patient compliance. The physician can also directly download the access history of the dispenser device 120 via the network 160 or when patient 102 brings the dispenser device 120 to the physician.

Information about the location, travel, loading, accessing, and/or attempted accessing of dispenser device 120 may be automatically communicated to appropriate entities or persons, based on the type of information. For example, if, after the dispenser has been filled at a pharmacy, the dispenser device 120 is detected as going in a direction or to a location that may indicate patient 102 may not be able to receive the medication at a desired time, authorities and/or patient 102 may be notified. If the dispenser device 120 has not moved for a long period of time at a location, a notification may be sent to patient 102 and/or caregiver, as the dispenser device 120 may be assumed lost or misplaced. In other examples, if the dispenser device 120 detects unauthorized persons trying to access the medications in the dispenser device 120, patient 102 and/or a caregiver may be notified to determine that the dispenser device 120 has not fallen into the wrong hands.

The present disclosure provides methods and systems that improve a patient's quality of life by organizing his or her medications, making it easily accessible and providing, in some embodiments, visual instruction as to when medications must be taken. The dispenser device used avoids the need for a patient to remember which medications have to be taken at a given time on any given day. The dispenser device can be pre-loaded with a patient's daily, weekly, or even monthly medications, and can be monitored to determine patient compliance. In addition, the dispenser device can contain the information needed (e.g., prescription, insurance, and payment information) by a pharmacy to dispense medications to a patient without compromising the patient's privacy.

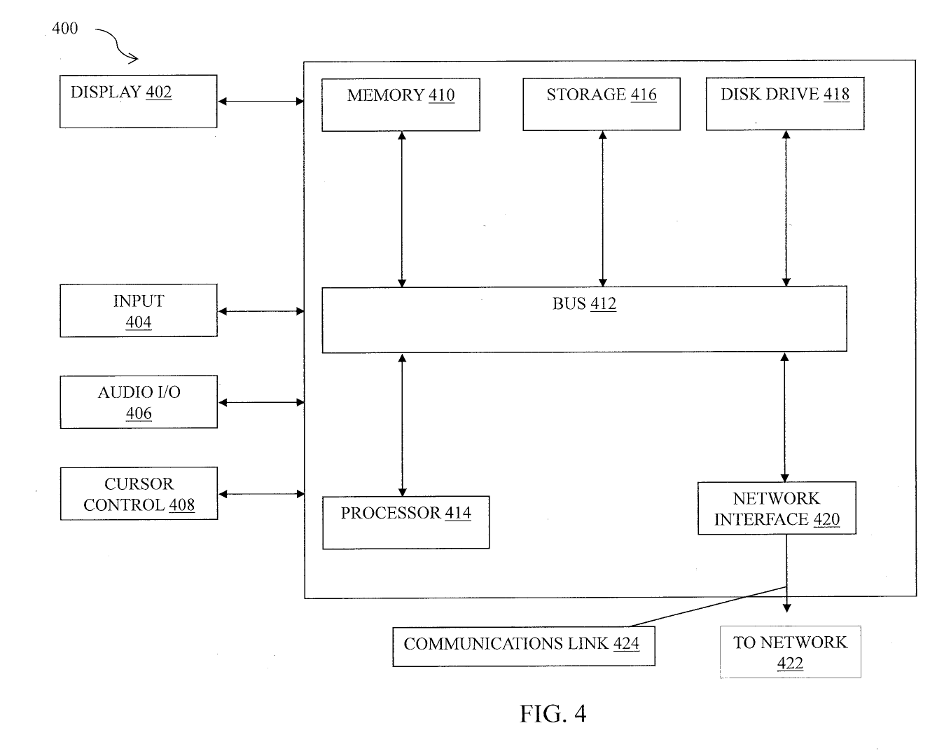

FIG. 4 is a block diagram of a computer system 400 suitable for implementing one or more embodiments of the present disclosure, including the dispenser device 120, the pharmacy server 130, the physician server 140, and the service provider server 180. In various implementations, the pharmacy server 130, physician server 140, and/or service provider server 180 may comprise a network computing device, such as a server. Thus, it should be appreciated that the devices 120, 130, 140, and 180 may be implemented as computer system 400 in a manner as follows.

Computer system 400 includes a bus 412 or other communication mechanism for communicating information data, signals, and information between various components of computer system 400. Components include an input/output (I/O) component 404 that processes a user (e.g., patient, pharmacy, physician, service provider) action, such as selecting keys from a keypad/keyboard, selecting one or more buttons or links, etc., and sends a corresponding signal to bus 412. I/O component 404 may also include an output component, such as a display 402 and a cursor control 408 (such as a keyboard, keypad, mouse, etc.). An optional audio input/output component 406 may also be included to allow a user to use voice for inputting information by converting audio signals. Audio I/O component 406 may allow the user to hear audio. A transceiver or network interface 420 transmits and receives signals between computer system 420 and other devices, such as another user device, a pharmacy server, physician server, or a service provider server via network 422. In one embodiment, the transmission is wireless, although other transmission mediums and methods may also be suitable. A processor 414, which can be a micro-controller, digital signal processor (DSP), or other processing component, processes these various signals, such as for display on computer system 400 or transmission to other devices via a communication link 424. Processor 414 may also control transmission of information, such as cookies or IP addresses, to other devices.

Components of computer system 400 also include a system memory component 410 (e.g., RAM), a static storage component 416 (e.g., ROM), and/or a disk drive 418. Computer system 400 performs specific operations by processor 414 and other components by executing one or more sequences of instructions contained in system memory component 410. For example, processor 414 can receive and transmit patient information, receive and process payment information, and authenticate a patient. Logic may be encoded in a computer readable medium, which may refer to any medium that participates in providing instructions to processor 414 for execution. Such a medium may take many forms, including but not limited to, non-volatile media, volatile media, and transmission media. In various implementations, non-volatile media includes optical or magnetic disks, volatile media includes dynamic memory, such as system memory component 410, and transmission media includes coaxial cables, copper wire, and fiber optics, including wires that comprise bus 412. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, a computer or hardware module in a home security system, a wireless Internet monitored device from a service provider, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 424 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

1. A dispenser device, comprising:
a container comprising:
a microprocessor component that stores patient profile information, wherein the patient profile information comprises prescription, insurance, and payment information;
a medication detector that detects medication consumption, access to the dispenser device, or both;
a security component that authenticates a person accessing the dispenser device; and
a location component that provides a location of the dispenser device.

2. The dispenser device of claim 1, wherein the microprocessor component further transmits medication consumption information to a physician.

3. The dispenser device of claim 2, wherein the microprocessor component further notifies a patient, physician, or both, when a patient has not accessed the dispenser device in a certain time period.

4. The dispenser device of claim 1, wherein the security component further monitors who accesses the dispenser device and when the dispenser device is accessed, and the location component further monitors where the dispenser device is accessed.

5. The dispenser device of claim 4, wherein the microprocessor component communicates who accessed the dispenser device, when the dispenser device was accessed, and where the dispenser device was accessed to a physician.

6. The dispenser device of claim 1, wherein the medication detector comprises one or more of a weight sensor, a motion sensor, or a sensor configured to detect when a person enters authentication data.

7. The dispenser device of claim 1, further comprising an informing component that notifies a patient when to take one or more medications, and which compartment in the dispenser device the one or more medications are located.

8. The dispenser device of claim 7, wherein the informing component comprises one or more of a light bulb or light emitting diode (LED) proximate to a compartment that includes a medication that is to be taken, a locking component that locks compartments in the dispenser device except for a compartment that includes a medication that is to be taken, or an opening component that opens a latch associated with a compartment that includes a medication that is to be taken, or any combination thereof.

9. The dispenser device of claim 1, wherein the microprocessor component further provides access to the dispenser device when a person is authenticated.

10. (Withdrawn and Previously Presented) A system, comprising:
a storage module that stores patient profile information;
a patient information module that transmits a request for patient information and receives the patient information from one or more physicians;
a patient profile module that generates a patient profile from the received patient information, provides the patient profile to the dispenser device of claim 1, and receives medication consumption information from the dispenser device; and
a payment module that receives a payment request from a pharmacy that loads one or more medications in the dispenser device and processes the payment request using a patient account.

11. The system of claim 10, wherein the patient profile information comprises one or more of a patient's medications, medication schedule, insurance information, and payment information.

12. The system of claim 11, wherein the pharmacy accesses the insurance information on the dispenser device to determine a payment amount.

13. The system of claim 10, wherein the patient information module further receives updated patient information from a physician and the patient profile module further updates the patient profile.

14. The system of claim 13, wherein the patient profile module further provides the updated patient profile to the dispenser device.

15. The system of claim 10, wherein the patient profile module further transmits the medication consumption information to one or more physicians.

16. A method for managing medications of a patient, comprising:
providing the dispenser device of claim 1 to a patient;
receiving, from a patient, physician, or both, patient information;
generating a patient profile from the received patient information;
transmitting, to the dispenser device, the patient profile;
receiving, from a pharmacy, a payment request for one or more medications loaded in the dispenser device;
processing the payment request;
authenticating the patient; and
instructing the dispenser device to provide access to the dispenser device when the patient is authenticated.

17. The method of claim 16, wherein the patient profile comprises one or more of a patient's medications, medication schedule, insurance information, and payment information.

18. The method of claim 16, wherein the pharmacy determines the one or more medications to load in the dispenser device by accessing the patient profile on the dispenser device.

19. The method of claim 16, further comprising receiving medication consumption information from the dispenser device.

20. The method of claim 19, further comprising transmitting, to a physician, the medication consumption information.
